(19) United States
(12) Patent Application Publication
(10) Pub. No.: US 2004/0099996 A1
(43) Pub. Date: May 27, 2004

(54) Process for manufacturing a shaped article, in particular powder stereolithographic or sintering process

(76) Inventor: Frank Herzog, Lichtenfels (DE)

Correspondence Address: LERNER AND GREENBERG, PA, P O BOX 2480, HOLLYWOOD, FL, 33022-2480, US

(21) Appl. No.: 10/704,262

(22) Filed: Nov. 7, 2003

(30) Foreign Application Priority Data
Nov. 7, 2002 (EP) 02024817.5

(51) Int. Cl. B29C 35/08; B29C 41/02

(52) U.S. Cl. 264/401; 264/497

(57) ABSTRACT

A process for manufacturing a shaped article, in particular a stereolithographic or a selective laser sintering process, uses radiation energy. A material made of a powder is deposited layer-by-layer onto a surface and is hardened by an application of radiation energy, in tracks, in which the radiation energy impinges the layer to be hardened. The powder in each track is melted entirely or at least partially. Parallel first tracks are applied next to one another at a lateral spacing and without lateral overlap with neighboring first parallel tracks, and second tracks of radiation energy intersecting with the first tracks are applied in order to ensure the hardening of the shaped article. Powder at the intersection points of the first and second tracks is melted at least partially.

### BACKGROUND OF THE INVENTION

### FIELD OF THE INVENTION

The present invention relates to a process for manufacturing shaped articles, in particular a stereolithographic or selective laser sintering process. A material made of a powder is deposited layer-by-layer onto a surface and hardened by applying radiation energy. The radiation energy, in tracks, impinges on the layers to be hardened, and the powder in each track is melted entirely or partially.

Such processes, which are also referred to as “rapid prototyping” or “rapid tooling” processes, can be carried out with plastic powders as well as with metal powders. Processes using plastic materials are typically referred to as stereolithographic processes, whereas processes in which metal powder of one or more compounds are hardened by an application of energy, and in particular processes in which the metal powder is melted partially or completely, are referred to as selective laser sintering processes.

In all of the above-noted processes, the powdery material is deposited layer-by-layer on a surface and is hardened by the application of radiation energy. Ordinarily, the radiation energy (which is typically focused laser radiation) impinges on the layer to be hardened in tracks, whereby the powder in each track is melted completely or partially.

A process wherein the tracks in which the radiation energy is applied to the powder layer overlap one another to the sides is known from German Patent DE 196 49 865, corresponding to U.S. Pat. No. 6,215,093. Thus, very intimate bonding of the melting or melted areas of the powder layer is attained. A disadvantage of the process is, however, that relatively long build times are necessary due to the overlap. Moreover, due to the row-by-row exposure of the layer from one side to the other, a heat gradient can be observed in the layer, which may lead to considerable stress in the shaped article under construction.

### SUMMARY OF THE INVENTION

It is accordingly an object of the invention to provide a process for manufacturing a shaped article that overcomes the above-mentioned disadvantages of the prior art methods of this general type, which allows the manufacture of a substantially stress-free shaped article with sufficient stiffness while cutting down on the build time.

With the foregoing and other objects in view there is provided, in accordance with the invention, a process for manufacturing a shaped article. The process includes depositing a material made of a powder layer-by-layer onto a surface, and applying radiation energy, in tracks, for hardening the material by the radiation energy impinging on a layer of the powder to be hardened. The powder in each track is melted entirely or partially. The applying step includes applying parallel first tracks of the radiation energy formed next to one another at a lateral spacing and without a lateral overlap with neighboring parallel first tracks, and applying second tracks of the radiation energy intersecting with the first tracks to ensure hardening of the shaped article. The powder disposed at intersection points of the first and second tracks is melted at least partially.

A core feature of the process is to apply parallel first tracks, in which the powdery material is hardened by the application of radiation energy, next to one another in such a manner that overlapping to the side with the adjacent parallel tracks becomes impossible. Thus, melted bulges are formed that do not, or substantially do not, contact each other or overlap with each other to the sides. In order to cross-link the melted strands of material that lie more or less unconnected next to one another, tracks of radiation energy are applied that intersect with the first tracks or with the strands of material within the tracks, wherein the intersection points of the first and the second tracks are melted at least partially. This forms a network of hardened strands of material that are fused to one another at least at the intersection points. The intersection points are not precisely defined points, and due to the fusing of the intersecting regions, the intersection points will spread two-dimensionally, which leads to intimate bonding of the entire structure.

The formed structure of the thus shaped article has proven to be relatively free from stress, and it is particularly advantageous that the process allows a stochastically distributed application of tracks, so that the powder layer can be heated with an even distribution, which prevents the occurrence of stress.

In principle, there is the possibility to form the second tracks intersecting the first tracks directly over the first tracks without depositing more powder, that is, to scan the structure of strands of material, which has been formed by the first application of energy, once again in a transverse direction. Thus, hardened cross-links between the strands of material are formed by the powder remains that are present between the strands of material and that have not yet been melted, which reinforces the network structure. However, it is also possible to first deposit a further powder layer onto the parallel strands of material, and then focus the second tracks of applied energy onto the further powder layer. In this way, complete second strands of material are formed that are disposed transverse to the strands of material of the first tracks and that fuse with the first strands of material, thus forming a lattice.

The second tracks may run at right angles to the first tracks, but other geometric configurations are also possible. Furthermore, it is possible to dispose the parallel strands of layers disposed on top of one another with a lateral offset. Also the intersection points of layers disposed on top of one another may be disposed with a lateral offset of, for example, half the mesh width of the resulting network.

It is possible to apply the first tracks in a parallel orientation within first selected areas and to apply the second tracks in parallel orientation within second selected areas, wherein the second areas overlap at least two or more first areas that lie next to one another. Therefore, the process forms first, more or less cross-linked networks of strands of material that lie next to one another, and then forms second networks of strands of material on top of the first networks, wherein the second networks of strands of material cover the area boundaries of the first networks. After the tracks of radiation energy have been applied in them, the individual areas may be provided with an edge track, thus connecting the ends of the strands of material formed by the tracks within each area. This is advantageous because it ensures for subsequent powder layers that the strands of material within the tracks already have a sufficiently firm interconnection.

Advantageously, stochastic distributions of the applied energy will avoid stresses in the hardened powdered material. As a network structure is formed layer by layer, it can be smoothened by a further application of radiation energy. It is possible to somewhat ablate the bumps of strands of material by melting them off, which facilitates the deposition of subsequent powder layers, because then the roller of the powder layering device cannot get caught at material structures that protrude too high. Further application of radiation energy may be carried out with scan vectors that define an angle with the scan vectors or tracks of the first or second tracks. The further application of radiation energy may be carried out in a rasterizing manner. In general, it is also possible to use a modified focus, that is, a modified radiation energy density, for the smoothing by further application of radiation energy. The modification of the focus may be achieved by adjusting the height of the platform of the assembly device supporting the shaped article under construction.

Other features which are considered as characteristic for the invention are set forth in the appended claims.

Although the invention is illustrated and described herein as embodied in a process for manufacturing a shaped article, in particular a powder stereolithographic or sintering process, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, top plan view of a first layer of a part with a first orientation of parallel tracks according the invention;

FIG. 2 is a diagrammatic, top plan view of a second layer of the part with tracks that are disposed perpendicularly to the first tracks in FIG. 1;

FIG. 3 is a cross-sectional view through several layers of the part;

FIGS. 4A and 4B are exploded views of two vertically adjacent layers with vertically adjacent but offset tracks;

FIG. 5 is a cross-sectional view through the layer configuration of FIGS. 4A, 4B;

FIG. 6 is a diagrammatic view of a layer of the part with first and second tracks as well as obliquely disposed third tracks for smoothing; and

FIGS. 7A-7C are diagrammatic cross-sectional views through a layer deposited on a substrate, in which the tracks overlap one another as is known in the prior art (FIG. 7A), the tracks do not overlap one another (FIG. 7B), and the tracks do not overlap, but are smoothed (FIG. 7C).

### DESCRIPTION OF THE PREFERRED EMBODIMENTS

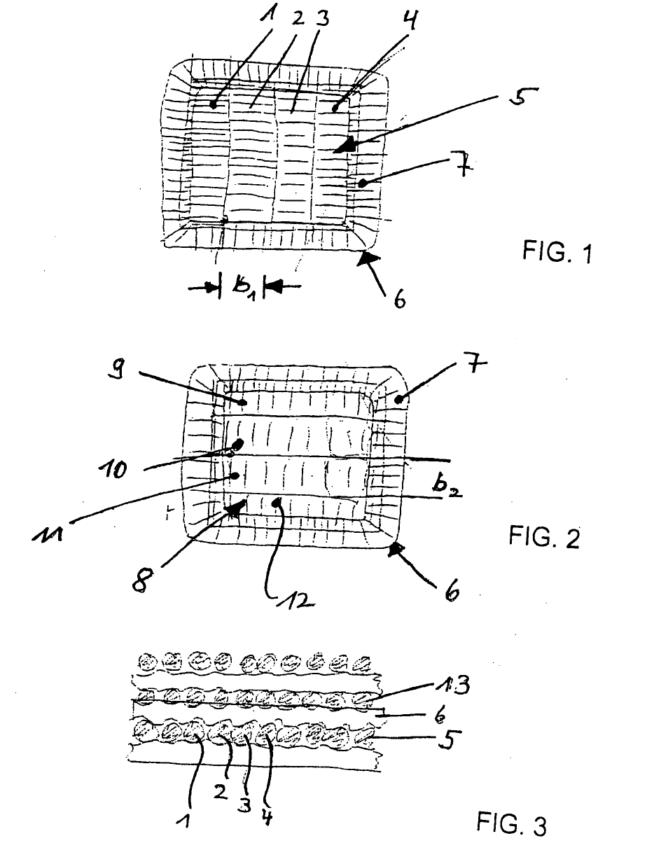

Referring now to the figures of the drawing in detail and first, particularly, to FIG. 1 thereof, there is shown an illustration for explaining a process according to an embodiment of the present invention. A material that is initially present in form of a powder is deposited layer by layer onto a surface or onto a substrate and is then scanned by a laser beam. Thus, the powder in each layer is melted completely or partially. FIG. 1 is a simplified illustration of how tracks 1 to 4 that run vertically in the drawing are disposed as first tracks in a first layer 5. A track width bi of the tracks 1 to 4 is set such that the tracks 1 to 4 are immediately adjacent to one another, but do not overlap. As soon as the inner structure of the layer 5 is completed, a part contour 6 is circumscribed with an edge track 7 connecting the ends of the tracks 1 to 4.

Thereafter, a layering device deposits more powdery material, and then a second layer 8 is consolidated with second tracks 9 to 12 that intersect with the first tracks 1 to 4, and that may be disposed at right angles as in this embodiment. Then, another edge track 7 can be disposed around the part contour 6.

Disregarding the edge tracks 7, a sectional part structure as shown diagrammatically in FIG. 3 is the result. The tracks of a third layer 13 are disposed congruently on top of the tracks 1 to 4 of the first layer 5, and the same is true for the tracks of every other of the following layers.

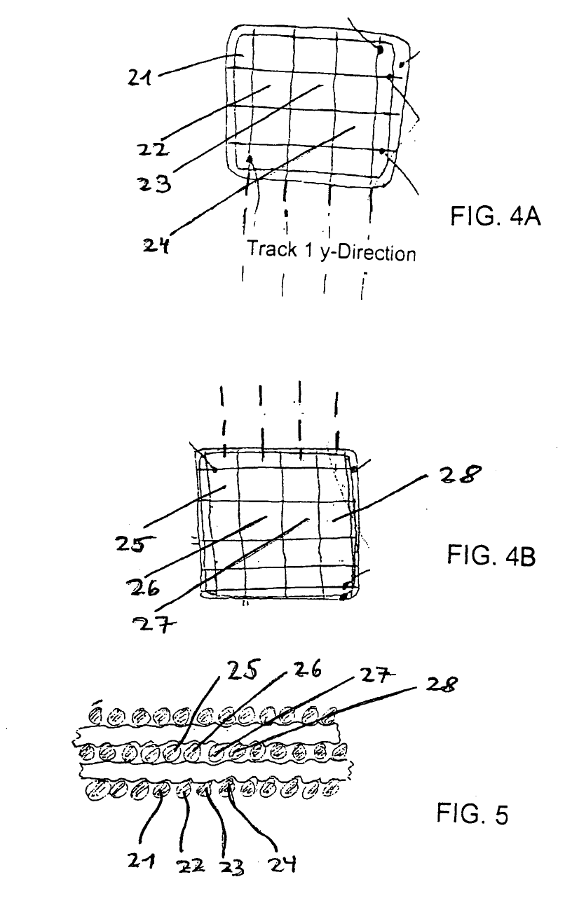

FIGS. 4A, 4B and 5 illustrate how the tracks that are disposed on top of one another may be disposed with an offset against one another.

It can be seen that the tracks 21 to 24 that run in vertical direction in FIG. 4A are shifted by half a track width to the side with respect to the tracks of the second following layer 25 to 28, FIG. 4B. The same may also be true for the tracks running in an X direction in FIGS. 4A, 4B. This results in a structure as illustrated in the sectional view shown in FIG. 5. Due to the staggered configuration, a relatively dense and heavily cross-linked lattice results, which leads to a very strong shaped article.

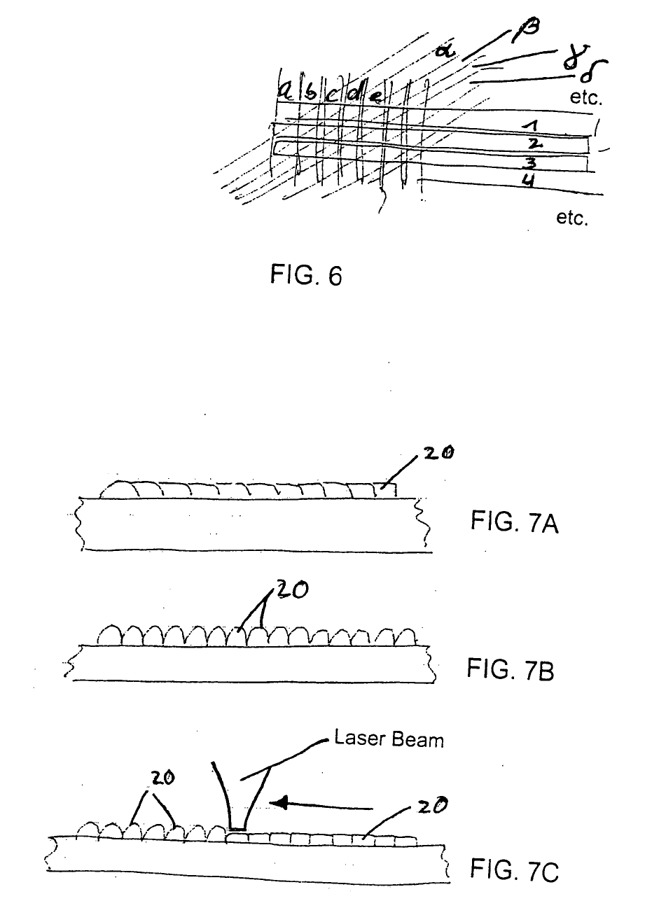

FIG. 6, for example, shows first tracks a, b, c, d and e that run vertically in the drawing, and that are intersected by horizontal tracks 1, 2, 3 and 4 at an angle of 90°. In order to achieve smoothing, it is possible to form oblique tracks α, β, γ, and δ that smoothen the furrowed surface of the consolidated strands of material 20, as illustrated on the right-hand side of FIG. 7C. Thus, a relatively smooth, condensed surface is attained.

I claim:

1. A process for manufacturing a shaped article, which comprises the steps of:
depositing a material made of a powder layer-by-layer onto a surface;
applying radiation energy, in tracks, for hardening the material by the radiation energy impinging on a layer of the powder to be hardened, and the powder in each track being melted one of entirely and partially, performing the applying step by the steps of:
applying parallel first tracks of the radiation energy formed next to one another at a lateral spacing and without a lateral overlap with neighboring parallel first tracks; and
applying second tracks of the radiation energy intersecting with the first tracks to ensure hardening of the shaped article, the powder disposed at intersection points of the first and second tracks being melted at least partially.

2. The process according to claim 1, which further comprises applying the second tracks immediately across the first tracks without a further deposition of the powder.

3. The process according to claim 1, which further comprises depositing a further layer of the powder before applying the second tracks across the first tracks.

4. The process according to claim 1, which further comprises forming the second tracks to run perpendicular to the first tracks.

5. The process according to claim 1, wherein the first and second tracks form a network of hardened strands formed of the material and the hardened strands are fused with one another at the intersection points.

6. The process according to claim 1, which further comprises forming parallel strands of layers of the material on top of one another with a lateral offset with respect to one another.

7. The process according to claim 1, which further comprises disposing the intersection points of layers of the material formed on top of one another with a lateral offset with respect to one another.

8. The process according to claim 6, which further comprises forming the lateral offset to be approximately half a mesh width.

9. The process according to claim 1, which further comprises:
applying the first tracks in a parallel configuration within first selected areas; and
applying the second tracks in a parallel configuration within second selected areas, and the second selected areas overlap with at least two of the first selected areas that are disposed next to one another.

10. The process according to claim 9, which further comprises applying an edge track of the radiation energy to each of the first and second selected areas track after the first and second tracks have been applied to the first and second selected areas.

11. The process according to claim 10, which further comprises forming the edge track to connect ends of strands of material that have been formed by the first and second tracks within an area.

12. The process according to claim 10, which further comprises forming the first or second tracks and the edge track corresponding therewith for each of the first and second areas as one circumscribed parallel lattice per layer of the material.

13. The process according to claim 12, which further comprises forming parallel lattices in the first and second selected areas to overlap, the parallel lattices include first parallel lattices formed by the first tracks and second parallel lattices formed by the second tracks that run perpendicularly to or at any other angle to the first tracks.

14. The process according to claim 1, which further comprises carrying out an application of the first and second tracks per layer in accordance with a stochastic distribution.

15. The process according to claim 9, which further comprises carrying out an order of the application of the radiation energy in the first and second selected areas in accordance with a stochastic distribution.

16. The process according to claim 1, which further comprises smoothing a network structure formed of hardened layers of the material by applying a further application of the radiation energy.

17. The process according to claim 16, which further comprises carrying out the further application of the radiation energy with scan vectors that define an angle with scan vectors of at least one of the first and second tracks.

18. The process according to claim 16, which further comprises carrying out the further application of the radiation energy in a rasterizing manner.

19. The process according to claim 16, which further comprises carrying out the further application of the radiation energy with a modified focus compared to an application of the radiation energy used in at least one of the first and second tracks.

20. The process according to claim 19, which further comprises achieving a modification of the focus by adjusting a height of a platform of a stereolithographic or sintering/melting device supporting the shaped article under construction.

21. The process according to claim 1, which further comprises fusing hardened strands of the material that are adjacent in a parallel configuration with one another by applying a further application of the radiation energy.

22. The process according to claim 7, which further comprises forming the lateral offset to be approximately half a mesh width.

23. The process according to claim 1, which further comprises partially ablating a network structure formed of the hardened layers of the material by applying a further application of the radiation energy.

24. A process being a stereolithographic process or a selective laser sintering process for manufacturing a shaped article, which comprises the steps of:
depositing a material made of a powder layer-by-layer onto a surface;
applying radiation energy, in tracks, for hardening the material by the radiation energy impinging a layer to be hardened, and the powder in each track being melted one of entirely and partially, performing the applying step by the steps of:
applying parallel first tracks of the radiation energy disposed next to one another at a lateral spacing and without lateral overlap with neighboring parallel first tracks resulting in first hardened strands; and
applying second tracks of radiation energy intersecting with the first tracks to ensure hardening of the shaped article and resulting in second hardened strands, the powder disposed at intersection points of the first and second hardened strands being melted at least partially.
